(19) United States
(12) Patent Application Publication
(10) Pub. No.: US 2025/0196267 A1
(43) Pub. Date: Jun. 19, 2025

(54) TRANSPARENT COMPONENT WITH A FUNCTIONALISED SURFACE

(71) Applicant: TRUMPF Laser GmbH, Schramberg (DE)

(72) Inventors: Felix Zimmermann, Ditzingen (DE); Max Kahmann, Nufringen (DE); Daniel Großmann, Schramberg (DE); Daniel Flamm, Ludwigsburg (DE); Myriam Kaiser, Heimsheim (DE); Jonas Kleiner, Leonberg (DE)

(21) Appl. No.: 19/071,789

(22) Filed: Mar. 6, 2025

Related U.S. Application Data
(63) Continuation of application No. PCT/EP2023/073378, filed on Aug. 25, 2023.

(30) Foreign Application Priority Data
Sep. 9, 2022 (DE) 10 2022 122 926.2

(51) Int. Cl. B23K 26/352; B23K 26/0622; B23K 26/40

(52) U.S. Cl. CPC B23K 26/355; B23K 26/0622; B23K 26/40

(57) ABSTRACT

A transparent component includes a functionalized surface. The functionalized surface has dimples and laser-induced periodic surface structures. The functionalized surface is functionalized by the dimples and the laser-induced periodic surface structures. The dimples and the laser-induced periodic surface structures spatially overlap. The dimples have a depth between 100 nm and 2000 nm.

### CROSS REFERENCE TO RELATED APPLICATIONS

This application is a continuation of International Application No. PCT/EP2023/073378 (WO 2024/052138 A1), filed on Aug. 25, 2023, and claims benefit to German Patent Application No. DE 10 2022 122 926.2, filed on Sep. 9, 2022. The aforementioned applications are hereby incorporated by reference herein.

### FIELD

Embodiments of the present invention relate to a transparent component with a functionalized surface.

### BACKGROUND

It is known that material can be removed from a component during laser material processing by vaporizing the material within the focal zone of the laser beam through a strong light-matter interaction. The resulting structural depressions are called dimples.

It is further known that, by means of a successive interaction of the same material region with at least two laser pulses, what are termed laser-induced periodic surface structures (LIPSSs) can also be produced.

In this regard, dimples and LIPSSs are suitable for the functionalization of component surfaces, wherein visual properties, wetting properties and tribological properties can, in particular, be influenced.

From DE 10 2017 006 358 A1, a method for producing a structured surface on a substrate is known, in which surface structures with dimensions in the sub-micrometer range are produced by treatment with an intensive pulsed laser beam.

From EP 2 692 855 B1, a device for cell biological and/or medical applications is known, wherein the device has at least one surface which at least partially has a surface structure produced by electromagnetic radiation, which has a microstructure superimposed by a nanostructure.

In addition, a laser-based surface modification of a quartz glass by LIPSSs is known from C. Kunz's “Selective production of multifunctional surfaces using laser-induced periodic surface structures” dissertation, Friedrich Schiller University Jena, 2021.

### SUMMARY

Embodiments of the present invention provide a transparent component. The transparent component includes a functionalized surface. The functionalized surface has dimples and laser-induced periodic surface structures. The functionalized surface is functionalized by the dimples and the laser-induced periodic surface structures. The dimples and the laser-induced periodic surface structures spatially overlap. The dimples have a depth between 100 nm and 2000 nm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a scanning electron microscope image of a dimple with laser-induced periodic surface structures (LIPSSs), according to some embodiments;

FIG. 2 shows a scanning electron microscope image of two overlapping dimples with LIPSSs, according to some embodiments;

FIG. 3 shows a schematic representation of the spatial overlap of two dimples with LIPSSs,, according to some embodiments; and

FIG. 4 shows a schematic representation of the spatial overlap of two dimples with LIPSSs in the overlap,, according to some embodiments.

### DETAILED DESCRIPTION

Embodiments of the present invention provide an improved transparent component with a functionalized surface.

According to some embb, a transparent component with a functionalized surface is provided, wherein the surface has dimples and LIPSSs and the surface is thereby functionalized. According to embodiments of the invention, the dimples and the LIPSSs spatially overlap.

The transparent material of the component can thus be a material such as a polymer or a plastic. The material to be processed can also be a semiconductor, for example an elemental semiconductor such as silicon or germanium, or a III-V semiconductor such as gallium arsenide, or an organic semiconductor or any other type of semiconductor. By way of example, the material can be a silicon wafer. In particular, the material can be a layer system, wherein each layer may be chosen from the group of metals, polymers, plastics or semiconductors. In particular, the material can also be glass, for example sapphire or quartz glass.

“Transparent” can mean that the component is optically transparent, i.e., transparent to the wavelengths visible to the human eye. For example, the material may transmit visible light more than 80% or more than 85% or more than 90% or more than 95% or more than 99%. “Transparent” can also mean that the material is transparent to the wavelength of a processing laser.

The dimples and the LIPSSs can be produced using a laser processing method. In this case, the laser provides the laser pulses of the laser beam, wherein the individual laser pulses form the laser beam in the beam propagation direction. The pulse duration of the laser pulses can be between 300 fs and 10 ps and/or the wavelength of the laser pulses can be between 300 nm and 3000 nm, preferably between 900 nm and 2200 nm.

This allows a laser wavelength to be selected, at which the material is transparent, so that the dimples and the LIPSSs can be introduced into the material via a nonlinear interaction. In addition, the short pulse duration can prevent unwanted heating of the material, which counteracts the formation of LIPSSs.

In addition, the laser can have a linear polarization, for example the degree of polarization of the laser beam can be more than 80%, preferably more than 95%.

Instead of individual laser pulses, the laser can also provide laser bursts, wherein each burst comprises the emission of multiple laser pulses. In this regard, the laser pulses can be emitted very shortly after one another, spaced apart by a few picoseconds to nanoseconds, for a specific time interval. In particular, the laser bursts can be GHz bursts, in which the sequence of successive laser pulses of the respective burst occurs in the GHz range. For example, a burst can contain between 2 and 10 laser pulses, with the time interval between the laser pulses being between 10 ns and 50 ns. However, a burst can also contain between 30 and 300 laser pulses, whereby the time interval between the laser pulses can be between 100 ps and 1000 ps.

For example, the length of the laser pulses can be between 100 ps and 100 ns, in particular between 1 ns and 20 ns, wherein the wavelength can be between 300 nm and 550 nm, in particular 355 nm, wherein the repetition frequency of the laser pulses can be between 10 kHz and 100 kHz, in particular between 10 kHz and 50 kHz, wherein the laser pulses can have an energy between 60 μJ and 300 μJ and 1 to 4 pulses can be emitted per spot.

For example, the length of the laser pulses can be between 200 fs and 1000 fs, in particular between 300 fs and 450 fs, wherein the wavelength can be between 900 nm and 2300 nm, in particular 1030 nm, wherein the repetition frequency of the laser pulses can be between 10 kHz and 400 kHz, wherein the laser pulses are emitted in laser bursts, wherein each laser burst can contain between 2 and 4 laser pulses, wherein the laser bursts can have an energy between 100 μJ and 400 μJ and the numerical aperture can be between 0.01 and 0.2, in particular 0.08.

The laser pulses are introduced into the material, wherein the energy of the laser beam is at least partially absorbed in the material, for example by nonlinear interactions, in particular by multiphoton processes.

Here, the focus of the laser beam can be located in the beam propagation direction above the surface of the material to be processed or under the surface, in the volume of the material to be processed. The focal position can also be located precisely on the surface of the material to be processed. In particular, the focal position can be within ten times the Rayleigh length from the surface, wherein the Rayleigh length is the distance along the optical axis that a laser beam needs until its cross-sectional area doubles, starting from the beam waist or focus.

In particular, the term “focus” can generally be understood as a targeted increase in intensity, wherein the laser energy converges in a “focal range”. In particular, the term “focus” is therefore used below irrespective of the actual beam shape used and the methods used to bring about an increase in intensity. The location of the increase in intensity along the beam propagation direction can also be influenced by “focusing”. For example, the increase in intensity can be virtually punctiform and the focal range can have a Gaussian intensity cross-section, as is provided by a Gaussian laser beam. The increase in intensity can also be linear, wherein a Bessel-type focal range is created around the focal position, as can be provided by a non-diffracting beam. Furthermore, other more complex beam shapes are also possible, the focal position of which extends in three dimensions, for example a multi-spot profile of Gaussian laser beams and/or non-Gaussian intensity distributions.

As a result of the energy absorbed from the laser beam, the material heats up in accordance with the intensity distribution of the laser and/or transitions into a temporary plasma state on account of the electromagnetic interaction between the laser and the material. In particular, in addition to linear absorption processes, non-linear absorption processes can also be used, which become accessible through the use of high laser energies or laser intensities. Accordingly, the material is modified particularly in the focus of the laser, as this is where the intensity of the laser beam is greatest. What this can achieve, in particular, is that some of the material can be detached from the material compound, the material for example melting or being evaporated. Hence, processing processes known per se are possible in relation to the interaction between the laser light and the material to be processed, these methods being known as laser drilling, percussion drilling or laser ablation, for example.

The interaction of the laser pulses with the material to be processed produces dimples on the surface of the transparent component.

A dimple is produced by the vaporization of the material on the surface due to the irradiated laser intensity. The material is vaporized particularly where the intensity of the laser beam exceeds a critical, material-specific processing threshold. Accordingly, the shape and form of the laser beam, especially the beam profile, is crucial for the shape and form of the dimples.

In the simplest case, the laser beam is a Gaussian laser beam with a Gaussian beam profile. There is a certain spatial area around the focal point in which the laser energy is above the critical threshold. In other words, there is an isointensity area in the intensity distribution of the laser beam at the focus within which the material can be vaporized. The shape and form of the dimple is determined from this isointensity surface.

In particular, dimples can therefore have a round or elliptical cross-section in the plane of the material surface, with the dimples having an increasing depth from the edge to the center. In particular, the cross-section of the dimples in the plane perpendicular to the surface can also be round or rounded.

By introducing dimples onto the surface of the material, the optical properties of the material can be determined, for example by scattering light passing through a transparent material at the dimples, thus making the material appear diffuse and/or matt. In particular, dimples on the surface of the material can suppress reflection from the material.

The dimples can be randomly arranged on the surface.

A random arrangement can occur if the spatial distances between the dimples have a random size. The spatial distances result, for example, from the center distances or the minimum distances from dimple edge to dimple edge.

In particular, for example, the spatial distribution of the dimples, including the size of the dimples, results in a spatial frequency distribution of the dimples via a Fourier transformation. The more irregular the distances between the dimples are, the greater the bandwidth of the spatial frequency distribution and the more diffusely an incident light beam is reflected by the transparent component.

In particular, “randomly arranged” can mean that the dimples are randomly distributed in the spatial frequency space. By displaying the position of the dimples in the spatial frequency space, it is also possible to identify potential spatial directions, along which interference of the reflected or transmitted light could occur in order to optimize the arrangement.

“Randomly distributed” can also mean that the spatial distribution of the dimples follows a random distribution, such as a uniform distribution, a Gaussian distribution, a triangular distribution, or another statistical distribution.

This has the advantage that the dimples are introduced into the material at an irregular distance from one another such that disruptive optical effects, such as interference, are reduced or avoided. In the present case, for example, the at least two laser pulses of a burst can spatially overlap. For example, each laser pulse can produce a dimple on its own, while what are termed LIPSSs are produced in the overlap. This happens when there is an excited plasmonic state in the first dimple with which the second laser pulse can interact, so that the heated material is oriented along the electric field of the laser pulse.

The combination of dimples and LIPSSs leads to a complex functionalization of the surface of the transparent component.

For example, the feel or roughness can be adjusted by the type and shape of the dimples, as well as the distribution of the dimples on the surface of the component. However, it is also possible to adjust the scattering of light and thus the optical properties of the material.

The size of the LIPSSs, however, can be used to further functionalize the surface, for example. For example, LIPSSs can be used to adjust the wetting properties of a surface because the LIPSSs change the contact angle between a liquid and the material. In addition, the tribological properties of the material can also be changed and, for example, the sliding properties of the material can be adjusted.

The combination of dimples and LIPSs allows the surface of the transparent component to be optically and mechanically functionalized.

The dimples can have a depth between 100 nm and 2000 nm, preferably between 200 nm and 1000 nm.

This makes it particularly advantageous to adjust the roughness of the surface, wherein extensive weakening of the material can be avoided.

The dimples can have a diameter between 3 μm and 25 μm, preferably between 3 μm and 10 μm.

This allows the diameter to be adjusted particularly advantageously to the microstructure required for functionalization.

The dimples can have variation in size relative to the diameter of between 5% to 80%.

For example, the size variation can be 50% and the diameter of the dimples can be 20 μm. The dimples on the surface can then have diameters between 10 μm and 30 μm

The LIPSSs can have a periodicity between 40 nm and 1000 nm, preferably between 50 nm and 300 nm.

The periodicity is determined by the average distance between two neighboring valleys or mountains in the profile of a LIPSS. The periodicity can particularly advantageously adjust the functionalization of the surface. For example, an LIPSS can have a periodicity of 100 nm for the medical field, so that the surface appears particularly hydrophobic. As a result, a surface treated in this way can be used particularly advantageously in endoscopes or laryngoscopes, for example, so that the correspondingly treated surfaces have a liquid-repellent effect and accordingly, when used in the body, for example, allow a clear view into the interior of the body. In particular, such a functionalized surface is particularly suitable for use in medical devices that enable optical access to the interior of the body.

The roughness of the transparent component can be between 0.05 μm and 1.5 μm.

This can produce a particularly high-quality haptic impression of the surface.

The surface roughness can be defined as a peak-to-valley value, i.e., the distance from the highest elevation to the lowest depression. However, it may also be that the roughness is defined as the standard deviation of the depth of the dimples.

The area filling of the surface with dimples can be between 20% and 95%.

The area filling of the surface is given by the area ratio of the processed surface by the dimples and the total surface of the transparent component. Depending on the desired roughness or functionalization, the area filling of the surface can be adapted.

In particular, when processing the surface, the dimples can also be introduced successively or in several passes, wherein the surface coverage is gradually increased, while distortion or smearing of the dimples is reduced.

In particular, at least two dimples can spatially overlap.

“Spatial overlap” can mean that the dimples touch at the edge, or that the dimples partially lie on top of each other, i.e., that a surface intersection of the dimples exists. The LIPSSs can cover less than 90% of the dimples.

For example, the LIPSS can be centered in the dimple. For example, a dimple can have a diameter of 10 μm, whereas the LIPSSs are only found in a surface area with a diameter of 9 μm.

However, it is also possible that two or more dimples overlap and LIPSSs are formed only in the spatial overlap.

In a preferred embodiment, the transparent component has dimples, wherein the dimples have a depth between 100 nm and 2000 nm, a diameter between 3 μm and 25 μm and a size variation relating to the diameter between 5% and 80%, wherein the laser-induced periodic surface structures have a periodicity between 40 nm and 1000 nm and the roughness of the functionalized surface is between 0.05 and 1.5 μm, wherein the area filling with dimples is between 20% and 95% and wherein the laser-induced periodic surface structures cover less than 90% of the dimples.

In a particularly preferred embodiment, the transparent component has dimples, wherein the dimples have a depth between 200 nm and 2000 nm, a diameter between 3 μm and 10 μm and a size variation relating to the diameter between 5% and 80%, wherein the laser-induced periodic surface structures have a periodicity between 50 nm and 300 nm and the roughness of the functionalized surface is between 0.05 and 1.5 μm, wherein the area filling with dimples is between 20% and 95% and the laser-induced periodic surface structures cover less than 90% of the dimples.

In a further particularly preferred embodiment, the dimples have a diameter between 13 μm and 20 μm, wherein the laser-induced periodic surface structures have a periodicity of between 650 nm and 1000 nm.

Preferred exemplary embodiments are described below with reference to the figures. In this case, elements that are the same, similar or have the same effect are provided with identical reference symbols in the different figures, and a repeated description of these elements is omitted in some instances, in order to avoid redundancies.

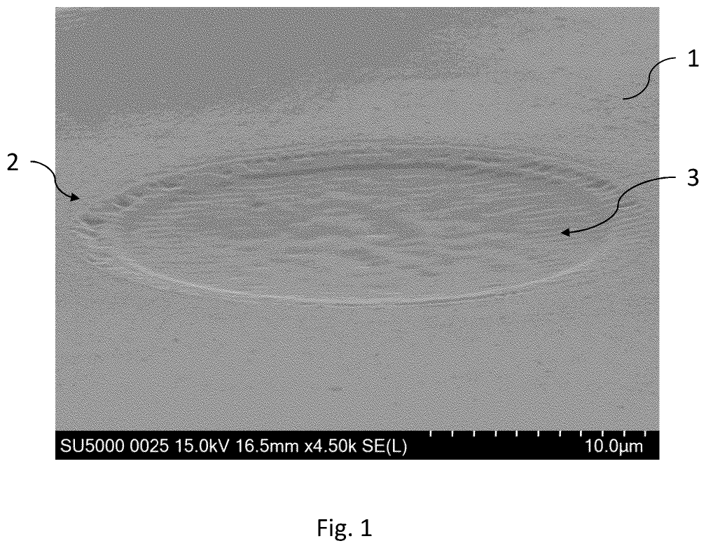

FIG. 1 shows a scanning electron microscope image of a dimple 2 with LIPSSs 3 on a transparent component 1. The dimple 2 has a diameter of 25 μm and a depth of 200 nm. In addition, there are LIPSSs 3 in the dimple 2, which can be recognized as a wave-like pattern. Such dimples 2 can be produced, for example, if at least two laser pulses, for example two laser pulses of a burt, are emitted one after the other onto the same location of the component 1.

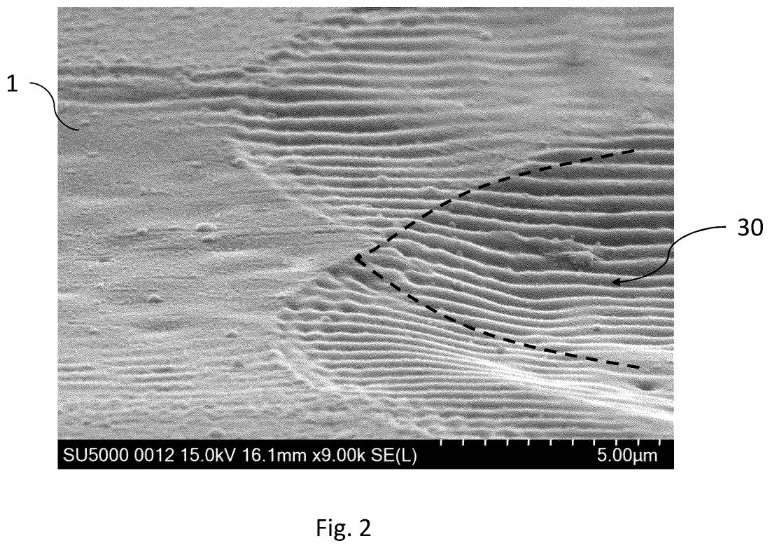

FIG. 2 shows a scanning electron microscope image of two overlapping dimples 2, where each dimple 2 already has LIPSSs 3. In the overlap 30 of the two dimples 2, the dimples 2 reinforce each other, i.e., there is a variation in depth. In addition, the LIPSSs 3 also overlap, so that a variation of the LIPSS results here to a certain extent from the spatial addition of the wave-like pattern. This allows the functionalization of the surface to be particularly finely adjusted.

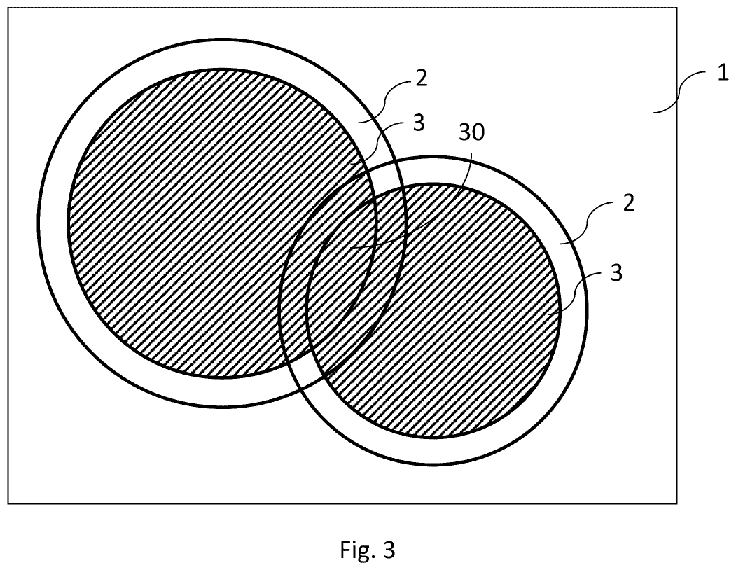

FIG. 3 shows a schematic representation of two dimples 2. The dimples 2, for example, have a different size of 25 μm and 15 μm. For example, both dimples 2 are produced with two laser pulses each from a laser burst, so that LIPSSs 3 are produced inside the dimples 2 (see FIG. 2). The LIPSSs overlap in the spatial overlap 30 of the dimples 2 and can thus reinforce each other.

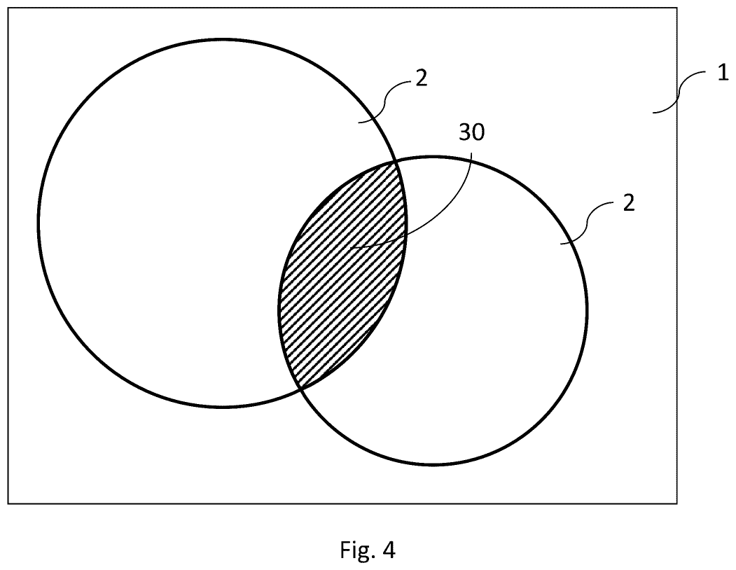

FIG. 4 shows a schematic representation of two dimples 2, each produced from a laser pulse. A first laser pulse therefore produced a first dimple 2, while a second laser pulse produced a second dimple 2. In the spatial overlap of the dimples 2, the second laser pulse can then interact with the plasmonic state caused by the first laser pulse. Accordingly, corresponding LIPSSs can only arise in the overlap.

The dimples 2 and LIPSSs 3, for example, produce advantageous optical and tribological properties of the surface of the transparent component.

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Transparent component
2 Dimple
3 LIPSS
30 Overlap

1. A transparent component comprising:
a functionalized surface, the functionalized surface having dimples and laser-induced periodic surface structures, the functionalized surface being functionalized by the dimples and the laser-induced periodic surface structures,
wherein
the dimples and the laser-induced periodic surface structures spatially overlap, and the dimples have a depth between 100 nm and 2000 nm.

2. The transparent component according to claim 1, wherein the dimples have a depth between 200 nm and 1000 nm.

3. The transparent component according to claim 1, wherein the dimples have a diameter between 3 μm and 30 μm.

4. The transparent component according to claim 1, wherein the dimples have a diameter between 3 μm and 10 μm.

5. The transparent component according to claim 1, wherein the dimples have a variation in size relative to a diameter of between 5% and 80%.

6. The transparent component according to claim 1, wherein the laser-induced periodic surface structures have a periodicity between 40 nm and 1000 nm, preferably a periodicity between 50 nm and 300 nm.

7. The transparent component according to claim 1, wherein the laser-induced periodic surface structures have a periodicity 50 nm and 300 nm.

8. The transparent component according to claim 1, wherein a roughness of the functionalized surface is between 0.05 and 1.5 μm.

9. The transparent component according to claim 8, wherein an area filling with the dimples is between 20% and 95%.

10. The transparent component according to claim 1, wherein the dimples are randomly arranged on the functionalized surface.

11. The transparent component according to claim 1, wherein at least two dimples spatially overlap.

12. The transparent component according to claim 1, wherein the laser-induced periodic surface structures cover less than 90% of the dimples.
